(19) United States
(12) Patent Application Publication
(10) Pub. No.: US 2006/0283454 A1
(43) Pub. Date: Dec. 21, 2006

(54) Face mask

(76) Inventors: Jim Delaney, Guelph (CA); Guy Plamondon, Edmonton (CA); Brenda Marks, Calgary (CA); Nancy Wong, Edmonton (CA)

Correspondence Address: DAVIS & BUJOLD, P.L.L.C., 112 PLEASANT STREET, CONCORD, NH, 03301, US

(21) Appl. No.: 11/445,937

(22) Filed: Jun. 2, 2006

Related U.S. Application Data
(60) Provisional application No. 60/687,072, filed on Jun. 3, 2005.

(51) Int. Cl. A62B 23/02; A62B 18/02; A62B 18/08

(52) U.S. Cl. 128/206.19; 128/205.25; 128/205.27; 128/206.12; 128/206.13; 128/206.18; 128/206.21; 128/206.27; 128/206.28

(57) ABSTRACT

A face mask includes a body adapted to fit contours of a human face. The body has opposed sides. A tie strap receiving channel is positioned along each of the opposed sides of the body. A single tie strap extends through both of the tie strap receiving channels. The tie strap is freely movable along each tie strap receiving channel.

This application claims priority from U.S. Provisional Application Ser. No. 60/687,072 filed Jun. 3, 2005.

### FIELD OF THE INVENTION

The present invention relates to a face mask of the type worn by health care workers and others in need of protection from contaminants as a contamination barrier.

### BACKGROUND OF THE INVENTION

Face masks are worn by individuals in many industrial and professional capacities to achieve a variety of ends. Some masks are designed to provide a contamination barrier between the wearer and a subject or object that the wearer is either protecting or needs protection against. Accordingly, if unfiltered contaminant-bearing air communicates with uncontaminated air the object of the mask is defeated either in whole or in part. A vast array of face mask configurations and combination of filtering materials are known to those skilled in the art.

An example of how masks are used may be drawn from the health care industry. A mask should filter air being exhaled by the wearer to prevent the transmission of airborne contaminants that may be contagious to other individuals or may contaminate the immediate environment. For example, a healthcare worker will wear a mask to prevent transmission of any contaminants to the patient or sterile field. Another reason is to filter air being inhaled by the wearer from any airborne particles from other individuals or the immediate environment. For example a health care worker will wear a mask to prevent the inhalation of an airborne contaminant resulting from a surgical procedure. A further reason is to act as a barrier against any bodily fluids or other liquids being splashed towards the wearer. Proper fit and seal for masks has therefore been a priority for manufacturers and consumers.

Examples of how others have attempted to improve the fit of face masks are described below:

Grier-Idris, in U.S. Pat. No. 4,662,005, describes a mask which provides a pouch-like conformable face mask including a generally rectangular filtration body.

Boyce, in U.S. Pat. No. 4,688,566, describes a mask which provides improved filtration through the introduction of an omega pleat and because of the positive facial lock around all edges of the mask.

Scheu, in U.S. Pat. No. 5,107,547, describes a face mask where the tie straps are joined by a slidable fastener forming a loop comprising straps and the top of the panel. The slidable fastener holds the straps in a loop of desired length and can be adjusted to increase or decrease the size of the loop.

Reese, in U.S. Pat. No. 5,553,608, describes a face mask which includes a filter body capable of filtering liquids, and gases, while providing improved breathability and comfort for extended periods of time. The tie straps are attached to flaps continuing from the filter body, some of which may be made from stretchable material, extending from the filter body to form a fluid seal between the periphery of the mask and the wearer's face.

Sukiennik, in U.S. Pat. No. 5,699,791, describes an attempt at a conformable face mask for health care workers. The use of elastomeric materials applied under tension helps define a plurality of gathers which facilitate a better donning and positioning of the mask. An elastomeric headband maintains a comfortable and efficient seal while a similar elastomeric chin strap helps provide a pouch-like enclosure for the wearer's chin.

Brunson, in U.S. Pat. No. 5,724,964, describes various gasket-type sealing materials, such as plastic film or hydrogel, which can be used to enhance the fluid barrier formed between the periphery of the mask and the wearer's face.

Brunson, in U.S. Pat. No. 6,055,982, describes a face mask which may include a continuous loop of material to secure the mask on a wearer's face.

Xue, in U.S. Pat. No. 6,332,465, describes a face mask having an elastic and polyolefin thermoplastic band attached by applying heat and pressure.

Bostock, in U.S. Pat. No. 6,886,563, describes a fold-flat mask which forms a cup-shape over the mouth and nose; the un-joined edges are meant to adapt around facial contours.

The fit of a mask is important to ensure that air goes through the filter membrane on both inspiration, and exhalation. Air that escapes around the periphery of the mask (known as “blow-by”) is a common problem with nearly all available masks, reduces the overall efficacy of the mask and therefore does not prevent the transmission of airborne contaminants. Much effort has been expended on developing face masks having improved filtration and/or sealing characteristics.

However, improvements in filtration and sealing characteristics of a mask have not necessarily resulted in increased comfort and fit of the mask. While some advances have been made, including the introduction of a secondary omega pleat under the breathing chambers to improve breathability, improvement is still desirable with respect to comfort enhancing features of face masks. In order to improve comfort and ease of donning, current medical-surgical masks are typically offered in one of three configurations: a tie-on style, an ear-loop style, and a cone-shaped style. Adjusting the tension of the ties at the beginning of a procedure is a challenge, and re-adjusting an uncomfortable fit without breaking the seal during a procedure is even more difficult. Thus, there exists a need for a face mask that maintains barrier properties while providing improved comfort to the wearer.

### SUMMARY OF THE INVENTION

According to the present invention there is provided a face mask, which includes a body adapted to fit contours of a human face. The body has opposed sides. A tie strap receiving channel is positioned along each of the opposed sides of the body. At least one tie strap extends through both of the tie strap receiving channels. The tie strap is freely movable along each tie strap receiving channel.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a front elevation view of a face mask constructed in accordance with the teachings of the present invention.

FIG. 2a is a perspective view of the face mask illustrated in FIG. 1, prior to expansion.

FIG. 2b is a perspective view of the face mask illustrated in FIG. 1, after expansion.

FIG. 3 is a side elevation view of the medical make illustrated in FIG. 1, worn by a health care professional.

FIG. 4 is a side elevation view of an alternative embodiment of face mask constructed in accordance with the teachings of the present invention.

FIG. 5 is a top plan view of a first embodiment of securing device for the face mask illustrated in FIG. 4.

FIG. 6 is a top plan view of a second embodiment of securing device for the face mask illustrated in FIG. 4.

FIG. 7 is a perspective view of a third embodiment of securing device for the face mask illustrated in FIG. 4.

FIG. 8 is a perspective view of a third embodiment of securing mechanism for the face mask illustrated in FIG. 4.

FIG. 9 is an exploded perspective view of an embodiment with an accessory in the form of a detachable visor.

FIG. 10 is a perspective view of an embodiment with the visor illustrated in FIG. 9 worn by a health care professional.

### DETAILED DESCRIPTION OF THE PREFERRED EMBODIMENT

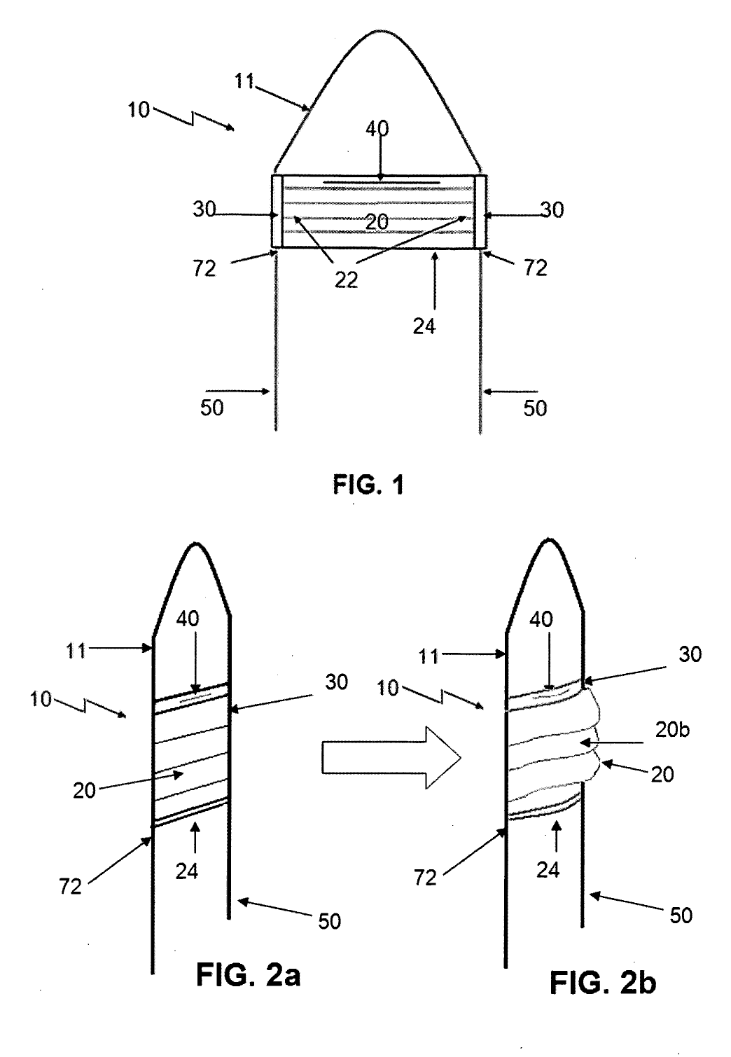

The preferred embodiments of the face mask, generally indicated by reference numeral 10, will now be described with reference to FIG. 1 through 10.

Structure and Relationship of Parts:

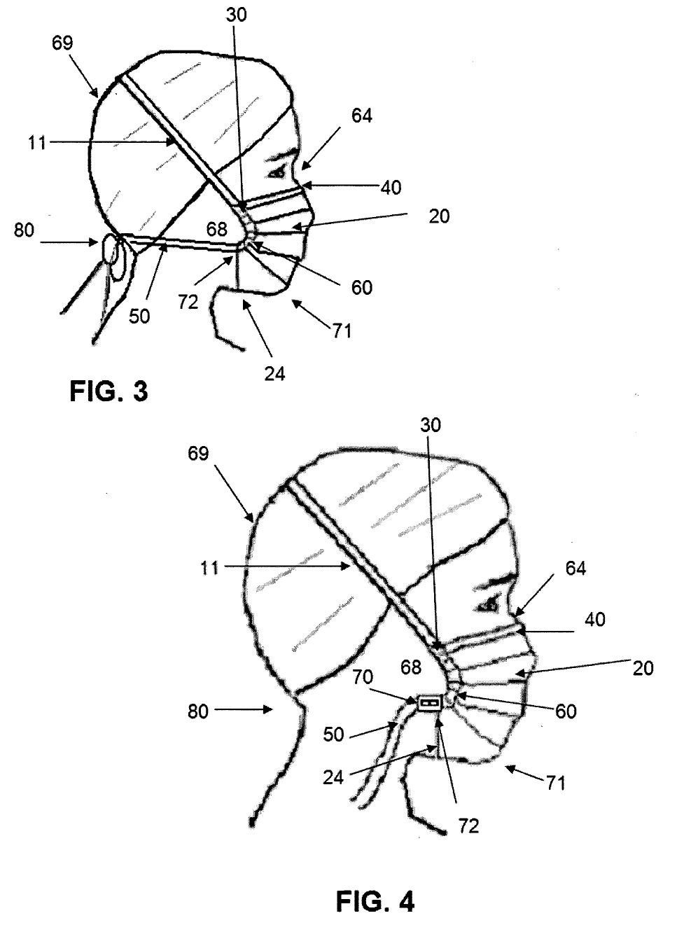

Referring to FIG. 1, face mask 10 includes a body 20 adapted to fit contours of a human face, as shown in FIG. 3. Body 20 has opposed sides 22. A tie strap receiving channel 30 is positioned along each of opposed sides 22 of body 20. A single tie strap 11 extends through both of tie strap receiving channels 30. It will be appreciated that two separate tie straps might be used instead of the single tie strap illustrated. Tie strap 11 is freely movable along each tie strap receiving channel 30.

Referring to FIGS. 2a and 2b, body 20 is in the form of a rectangular shaped panel made from two or more layers of non-woven materials. A preferred embodiment includes an inner liner which is in contact with the user's face, a middle filtration layer typically made of melt-blown filter media, and an external protective layer. It is preferred that body 20 have a finished lower edge 24 and an upper edge containing a malleable nose piece 40. Sides 22 may be folded and secured to form a hollow casing or may feature added-on piping or casing to form channel 30. Referring to FIG. 1, tie strap 11 is threaded in a U-shape through channel 30 on one of sides 22, and back down through channel 30 on the other of sides 22. Referring to FIG. 3, the loop thus created is intended to go over the wearer's head 69. Tie strap 11 is able to slide within channel 30, so that when tie strap 11 is pulled against any anchoring force, such as the wearer's head 69, channel 30 is compressed to form gathers 60. Once channel 30 is gathered, the user may further adjust mask 10 up or down along tie strap 11 to secure mask 10 into the correct position about the face.

Operation:

Referring to FIG. 1 through 3, to don mask 10, the wearer performs the following steps. Referring to FIGS. 2a and 2b, the wearer pushes the folds of mask body 20 outwards from the inside of mask 10 to enlarge the breathing space available 20b. Referring to FIG. 3, the wearer holds the mask panel of body 20 in front of his or her mouth and nose. The wearer then presses and shapes malleable nose piece 40 to fit around the bridge of his or her nose 64. Tie strap 11 is then placed over and behind the head 69. The wearer then grabs tie portion 50 of tie strap 11 on either side of mask 10 below body 20. Tie portions 50 are pulled downwards and then backwards, so that tie strap 11 is tightened behind the head 69 to form gathers 60 along sides 22 of mask 10 to securely fit around the nose 64, cheeks 68, and under the chin 71. The user then ties the portions 50 of tie strap 11 behind the head and/or neck 80.

Variations:

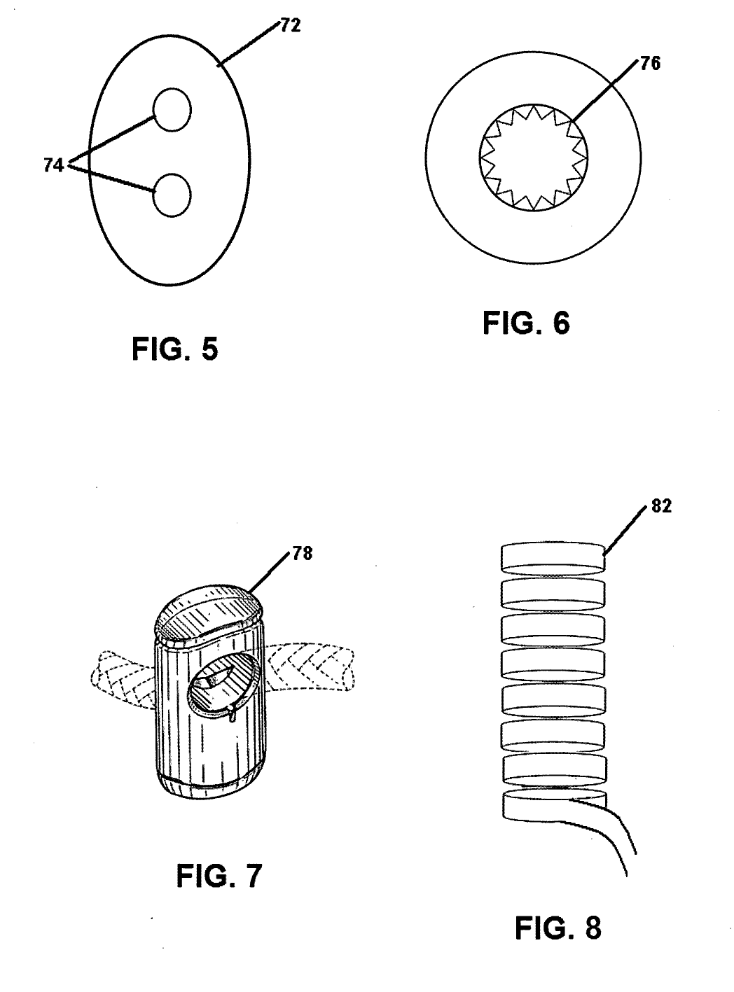

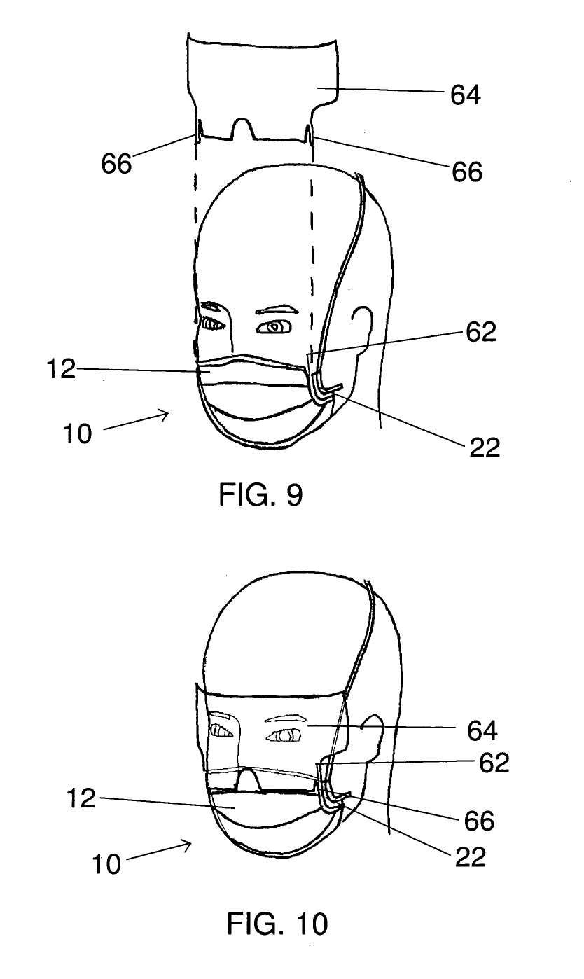

Referring to FIG. 4, there is illustrated a second or alternative embodiment, which is identical in all respects to the embodiment described above, with the exception of the manner in which it is tied. A securing device 70 is positioned at the bottom end 72 of channel 30. When the user pulls tie strap 11 down and out from channel 30, securing device 70 holds tie strap 11 at that tightness and prevents tie strap 11 from sliding back up into channel 30. There are a many different types of securing devices 70. A few examples are illustrated in FIG. 5 through 8. Referring to FIG. 5, there is illustrated a flat tab 72 with two eyes 74 through which tie strap 11 is threaded to hold the desired tie position. Referring to FIG. 6, there is illustrated a toothed eyelet 76 to allow tie strap 11 to slide one way (to tighten) with ease, and the other way (to loosen) with resistance. Referring to FIG. 7, there is illustrated a cord lock device 78. It will be appreciated that any other securing device or mechanism, including the nature of the tie(s) itself, such as a spring lace 82 as seen in FIG. 8, may be used to prevent tie strap 11 from slipping within channel 30 and thus maintaining the gathers 60 along each side 22 of mask 10. Referring to FIGS. 9 and 10, mask 10 is shown with accessory attachment channels 62 provided along each side 22 of body 12. An accessory is provided in the form of a visor 64 is provided. Visor 64 has two depending male members 66, which are adapted for insertion into accessory attachment channels 62 in order to secure visor 64 to body 12 of mask 10. Although visor 64 has been selected for illustration, it will be appreciated that there are a variety of other accessories that could be attached is a like manner, including malleable stiffeners and splash guards.

Face mask 10 improves the fit and comfort of the wearer and reduces the blow-by associated with existing surgical style face masks. A shield, visor or other accessories may be attached to the improved face mask in accordance with several aspects of the present invention.

Heretofore, makers of masks have unibody construction, i.e., the tie straps are secured directly to the body of the mask by sewing, adhesive, ultrasonic welding or similar means, making the mask a one-piece product. The inventors hereof have found that by making the mask in at least two pieces and allowing the ties to move independently from the body of the mask, the mask more effectively adjusts to create a snug and comfortable fit to the form of the users head. The tight fit inhibits the passage of fluids and gases between the periphery of the mask and the wearer's face while providing enhanced comfort to the wearer. The present invention may be incorporated into standard pleated style face masks, off-the-face style masks, or molded cone style masks. The body of the mask has opposed sides. A tie strap receiving channel is positioned along each side of the opposed sides of the body of the mask. One or several tie straps can be adjusted freely to match the morphology of the wearer. The tie strap moves freely within the tie strap receiving channel.

In addition to fit and comfort, the multi component construction allows a greater variety of embodiments as the properties of the mask may be varied according to the intended use. Integrating tie straps, mask bodies and other accessories after separate manufacture allows the manufacturer of final products to customize to the specifications of an individual user. For example, in some applications, such as in the sterile surgical theatre, the user requires a splash resistant body and tearaway tie straps. In other applications such as occupational health, the user preference may still be similar filtration and splash resistance but to have a more robust or elastic tie strap designed so the users can secure the tie strap themselves. The manufacturer can add steps in the manufacturing process that create at least one channel parallel to the tie strap receiving channels to secure a visor. The tie strap may be composed of multiple materials, abutted or joined.

The present invention allows for the optimization of the filtration capability of the mask in regards to resistance to the infiltration of liquids and/or aerosols and/or gases while allowing for a substantially improved fit and comfort between the periphery of the mask and the contours of a wearer's face. An optically clear or tinted visor may be attached to the filter body to protect the wearer's eyes and portions of the wearer's face which are not covered by the mask.

Definitions

Receiving channel as used herein means a channel comprising one or more segments through which an object may be inserted. In a preferred embodiment of this invention, receiving channels are located on opposing sides of a face mask with at least one tie strap passing through in a manner that allows gathers to form when a tie strap or straps are pulled against an anchoring force at each of the opposing sides. In one preferred embodiment, the receiving channel invention is made from piping. In another it is formed by folding material. The dimensions and friction characteristics of the receiving channel in relation to the tie strap materials may be varied according to application.

Tie strap as used herein is used as a means of securing the mask to the face of the wearer. The tie strap can embody multiple forms, including a loop, tearaway, strap, fastener, etc. The tie strap may be made of various materials, including at least part elastomeric material. The tie strap may be built by joining two different materials, one which may be tearaway and the other which may be elastomeric material. Its size may also be dependent on the size of the aperture and the length may vary.

The fit of the mask is a physical means of ensuring good sealing characteristics. A good fitting mask adjusts to varying facial sizes and contouring, thereby reducing blow-by, leakages, gaps and such. A good fit also leads to increased comfort for the wearer of the mask.

Building a tearaway tie includes selecting a material of the appropriate tensile strength and or subjecting the material to a mechanical treatment resulting in the ability to break the tie strap of the mask quickly when removing the mask without untying the securing means.

Advantages:

The current configurations have several limitations. With the current tie-on style, the wearer dangles the mask in front of the face, and then pinches a malleable nose-piece to hold it somewhat in place. The user then places the upper ties above their head and ties a bow or knot to secure the upper tie. The user then places the lower ties behind their head or neck, and again ties the straps. It is difficult to get the desired tension on both sets of ties, and the tie bows or knots must be undone in order to adjust the tightness. The mask must be secured very tightly in order to have the sides of the mask fit against the wearer's cheeks, which decreases the amount of breathing space inside the mask, reduces the ability of the user to speak, and generally reduces the overall comfort level of the wearer. The ear-loop style masks may be too tight or too loose, depending on the face size and ear positioning of the wearer; and the thin elastic straps may be irritating to the skin behind the ear. The stiff edges of a molded cone-shape mask may be irritating to the user's face, and the elastic head straps may be irritating to the wearer's head and/or get tangled with the wearer's hair.

In contrast, the present invention offers a unique method of securing the face mask, and provides a number of benefits to the wearer:

The mask is easier to put on than the current two-tie configuration because the user does not need to tie the loop above their head

The mask is easier to remove than the current two-tie configuration because there are fewer bows or knots to untie

The tightness of the mask is easily adjusted before and after the user secures the tie, by sliding the mask panel up or down on the ties

The mask is gathered into pleats along the sides of the mask, ensuring a conformable fit along the sides of the face and below the chin, thus reducing blow-by

The single loop behind the wearers head cannot come undone like a tied bow, thus preventing the possibility of the tie falling down over a surgical field

A single loop behind the head offers an esthetically cleaner look than a tied bow or knot

The channeled or tunneled tie allows a flat shipping profile, converting to a three-dimensional profile once the tie is tightened and the sides are gathered

The mask offers a conformable, more customized fit not provided by ear-loop masks

The single soft loop behind the head offers more comfort than the fixed elastic loops of an ear-loop mask

The soft tie of the mask offers more comfort than the elastic head straps of a molded cone-shape mask

The mask offers three-dimensional pocket by forming side gathers, but is softer to the user's skin than a molded cone-shape mask

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A face mask, comprising:
a body adapted to fit contours of a human face, the body having opposed sides;
a tie strap receiving channel being positioned along each of the opposed sides of the body;
at least one tie strap extending through the tie strap receiving channels, the at least one tie strap being freely movable along each tie strap receiving channel.

2. The face mask as defined in claim 1, wherein a single tie strap extends through both of the tie strap receiving channels.

3. The face mask as defined in claim 1, wherein the tightening of the at least one tie strap causes gathers to form along in the body to customize the fit to the contours of the wearers face and to close gaps along the sides of the body.

4. The face mask as defined in claim 1, wherein at least one tie securing device is positioned on the at least one tie strap to place the at least one tie strap in tension, secure the at least one tie strap in position and prevent inadvertent movement within the tie strap receiving channels.

5. The face mask as defined in claim 4, wherein the at least one tie securing device is a coiled spring lace end on the at least one tie strap.

6. The face mask as defined in claim 4, wherein the at least one tie securing device is a flat tab with two eyes through which the at least one tie strap is threaded to hold the desired tie position.

7. The face mask as defined in claim 4, wherein the at least one tie securing device is a toothed eyelet that allows the at least one tie strap to slide one way with ease, and the other way with resistance.

8. The face mask as defined in claim 4, wherein the at least one tie securing device is a cord lock device.

9. The face mask as defined in claim 1, wherein a filtration material adapted to act as a barrier to selected contaminants is incorporated within the body.

10. The face mask as defined in claim 1, wherein at least one accessory attachment channel is provided on the body.

11. The face mask as defined in claim 10, wherein an accessory is provided that has at least one male member adapted for insertion into the accessory attachment channel, the accessory being selected from a group consisting of malleable stiffeners, visors, and splash guards.

12. The face mask as defined in claim 1, wherein the tie strap receiving channels comprises piping.

13. The face mask as defined in claim 1, wherein the tie strap comprises a tearaway material adapted to mechanically fail when subjected to a force exceeding a preset threshold.

14. A face mask, comprising:
a body adapted to fit contours of a human face, the body having opposed sides;
tie strap receiving channel being positioned along each of the opposed sides of the body;
a single tie strap extending through both of the tie strap receiving channels, the single tie strap being freely movable along each tie strap receiving channel, the tightening of the single tie strap causing gathers to form along in the body to customize the fit of the body to the contours of the wearers face and to close gaps along the sides of the body.

15. The face mask as defined in claim 14, wherein tie securing devices are positioned in opposed relation on the single tie strap to place the single tie strap in tension, secure the single tie strap in position and prevent inadvertent movement within the tie strap receiving channels.

16. The face mask as defined in claim 15, wherein the tie securing devices are coiled spring lace ends on the single tie strap.

17. The face mask as defined in claim 15, wherein the tie securing device is a flat tab with two eyes through which opposed ends of the single tie strap are threaded to hold the desired tie position.

18. The face mask as defined in claim 15, wherein the tie securing devices are toothed eyelets that allows the opposed ends of the single tie strap to slide one way with ease, and the other way with resistance.

19. The face mask as defined in claim 15, wherein the tie securing devices are cord lock devices.
